(19) United States
(12) Patent Application Publication
(10) Pub. No.: US 2014/0286035 A1
(43) Pub. Date: Sep. 25, 2014

(54) METHOD FOR FIXING AN OPTICAL UNIT AND AN ILLUMINATION DEVICE

(71) Applicant: Hella KGaA Hueck & Co., Lippstadt (DE)

(72) Inventors: Miguel Lebrato-Rastrojo, Paderborn (DE); Heinrich Schäfer, Bad Wuennenberg (DE)

(73) Assignee: Hella KGaA Hueck & Co., Lippstadt (DE)

(21) Appl. No.: 14/181,950

(22) Filed: Feb. 17, 2014

(30) Foreign Application Priority Data
Mar. 20, 2013 (DE) 102013102835.7

(51) Int. Cl. F21S 8/10; B32B 37/00

(52) U.S. Cl. CPC F21S 48/21; B32B 37/00
USPC 362/523; 156/60

(57) ABSTRACT

A method for fixing an optical unit on a carrier, includes the steps of connecting the optical unit to the carrier with a substance-to-substance bond, and supporting the optical unit so that it can move relative to the carrier in a specified alignment direction by means of an alignment pin guided in an elongated hole before the substance-to-substance bonding of the optical unit to the carrier until the optical unit has reached a specified target position relative to the carrier where the substance-to-substance bond between the optical unit and the carrier is produced.

### CROSS REFERENCE

This application claims priority to German Patent Application No. 10 2013 102835.7, filed Mar. 20, 2013.

### TECHNICAL FIELD OF THE INVENTION

The invention relates to a method for fixing an optical unit on a carrier, wherein the optical unit is connected to the carrier with a substance-to-substance bond.

Furthermore, the invention relates to an illumination device for vehicles with an optical unit and with a carrier that are connected to each other in a target position.

### BACKGROUND OF THE INVENTION

From WO 2006/097067 A1, a method for fixing an optical unit on a carrier is known in which alignment pins are inserted into corresponding holes of the carrier for aligning the optical unit. In this way, a mechanical connection between the optical unit and the carrier is already established. In addition, the mechanical connection can also be realized by means of an adhesive. A disadvantage to the known method is that the target position between the optical unit and the carrier is already specified by the connection between the alignment pin and the hole. A subsequent alignment at the assembly location is no longer possible.

The problem of the present invention is therefore to disclose a method for fixing an optical unit to a carrier or an illumination device, so that alignment and subsequent force-free and torque-free connection of the optical unit and the carrier are guaranteed in a simple way.

### SUMMARY OF THE INVENTION

To solve this problem, the invention in connection with the preamble of claim 1 is characterized in that the optical unit is supported so that it can move relative to the carrier in a specified alignment direction by means of an alignment pin guided in an elongated hole before the substance-to-substance bonding of the optical unit to the carrier until the optical unit has reached a specified target position relative to the carrier where the substance-to-substance bond between the optical unit and the carrier is produced.

The invention allows a simple alignment and/or adjustment of an optical unit relative to a carrier in an assembled position, wherein, after the alignment process is completed, a fixing of the parts is realized in a cost-effective and processing-optimized manner by substance-to-substance bonding.

According to one preferred embodiment of the invention, the substance-to-substance bonding is produced in at least two fixing fields spaced apart from each other in the alignment direction. In this way, a secure fixing is guaranteed.

According to one preferred embodiment of the invention, the substance-to-substance bond is realized by adhesion or welding that permit, in particular, a force-free and torque-free connection method.

To solve this problem, the invention with the preamble of claim 4 is characterized in that a pin-elongated hole connection is provided for moving the optical unit into the target position relative to the carrier, wherein this pin-elongated hole connection supports the optical unit so that it can move relative to the carrier in the alignment direction.

The special advantage of the illumination device according to the invention consists in that an alignment and fixing of optical units on a carrier can be performed in a simple way. In particular, a cost-optimized and processing-optimized fixing can be guaranteed by the substance-to-substance bonding.

According to one refinement of the invention, an alignment pin projects from a back side of the optical unit and is supported guided in an elongated hole. As soon as the optical unit has reached the target position relative to the carrier, a defined assembly position can be realized through substance-to-substance bonding.

According to one refinement of the invention, the optical unit has a heat sink on whose front side a reflector and an LED light source are attached. The heat sink has like the carrier an arc-shaped construction, wherein the desired target position can be realized through slight movement or rotation of the alignment pin in the elongated hole.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 a side view of an illumination device and

FIG. 2 a rear view of the illumination device.

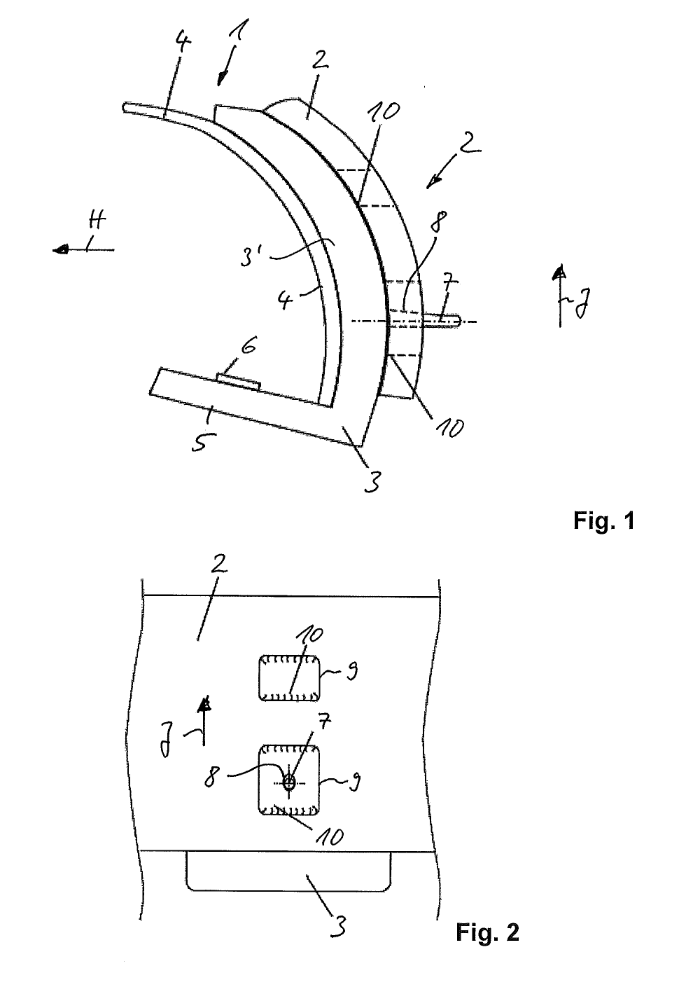

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

An illumination device for vehicles can be arranged, for example, in a rear or front area of the vehicle for generating a signal function. The illumination device can be used, for example, for generating a stop light, tail light, direction indicator, or daytime running light function.

The illumination device has an optical unit 1 and a carrier 2 that are arranged in a not-shown housing of the illumination device.

The optical unit 1 has a heat sink 3 on whose front a reflector 4 is attached in the main radiation direction H of the illumination device. The heat sink 3 has, in a lower end area, a projection 5 that extends in the main radiation direction H and on whose top side an LED light source 6 is arranged. The LED light source 6 can be formed, for example, by an LED chip that is positioned on a not-shown circuit board that is mounted, in turn, on the projection 5 of the heat sink 3. A main section 3′ of the heat sink 3 extending upward in the vertical direction has an arc-shaped construction like the reflector 4. For example, the main section 3′ of the heat sink 3 or the reflector 4 can have a parabolic shape, wherein light emitted by the LED light source 6 is deflected in the main radiation direction H at the reflector 4 and a specified light distribution is emitted accordingly.

The optical unit 1 formed in this way is supplied as an assembly to the similarly arc-shaped carrier 2, wherein an alignment pin 7 projecting from a back side of the main section 3′ engages in an elongated hole 8 of the carrier 2. Thus, in the assembled position, a pin-elongated hole connection between the optical unit 1 and the carrier 2 is created that permits an alignment in the alignment direction J corresponding to the longitudinal direction of the elongated hole 8. The optical unit 1 is thus supported so that it can move guided in the elongated hole 8. The optical unit I can thus be aligned relative to the carrier 2 in the assembled position until the desired target position has been assumed. The alignment is advantageously performed by means of not-shown tools.

As soon as the target position of the optical unit 1 relative to the carrier 2 has been reached, a substance-to-substance bond is produced between the optical unit 1 and the carrier 2 in two fixing fields 9 arranged spaced apart from each other. The two fixing fields 9 are spaced apart from each other in the alignment direction J and permit a long-term, stable connection between the optical unit 1 and the carrier 2. In the present embodiment, the fixing fields 9 have a four-sided construction. The fixing is performed with a substance-to-substance bond through adhesion or welding, wherein corresponding weld seams 10 run transverse to the alignment direction J.

The carrier 2 can be constructed as a support frame on which additional optical units 1 can be fastened. The support frame 2 is fixed on the housing of the illumination device by means of a not-shown fastener.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

### LIST OF REFERENCE SYMBOLS

1 Optical unit
2 Carrier
3, 3′ Heat sink, main section
4 Reflector
5 Projection
6 LED light source
7 Alignment pin
8 Elongated hole
9 Fixing fields
10 Weld seams
H Main radiation direction
J Alignment direction

1. A method for fixing an optical unit on a carrier, wherein the optical unit is connected to the carrier with a substance-to-substance bond, comprising the steps of:
Supporting the optical unit so that it can move relative to the carrier in a specified alignment direction by means of an alignment pin guided in an elongated hole before the substance-to-substance bonding of the optical unit to the carrier until the optical unit has reached a specified target position relative to the carrier where the substance-to-substance bond between the optical unit and the carrier is produced.

2. The method according to claim 1, wherein the substance-to-substance bond is produced in two fixing fields spaced apart from each other in the alignment direction.

3. The method according to claim 1, wherein the substance-to-substance bond is generated by adhesion or welding.

4. An illumination device for vehicles, comprising:
an optical unit and with a carrier that are connected to each other in a target position, wherein a pin-elongated hole connection is provided for moving the optical unit into the target position relative to the carrier, and
wherein this pin-elongated hole connection supports the optical unit so that it can move relative to the carrier in the alignment direction.

5. The illumination device according to claim 4, wherein the pin-elongated hole connection comprises an alignment pin that is supported so that it can move and is guided in the longitudinal direction of an elongated hole.

6. The illumination device according to claim 4, wherein the alignment pin projects from a back side of the optical unit.

7. The illumination device according to claim 4, wherein the optical unit is connected to the carrier by welding or adhesion in at least two fixing fields arranged spaced apart from each other in the alignment direction.

8. The illumination device according to claim 4, wherein the carrier is formed as a support frame and the support frame and the optical unit have a construction that bulges in the alignment direction.

9. The illumination device according to claim 4, wherein the optical unit has a heat sink on which a flat surface of a reflector contacts a front side in the main radiation direction and a lower projection for holding an LED light source.

10. The illumination device according to claim 7, wherein the fixing fields have a four-sided shape.
